(19) United States
(12) Patent Application Publication
(10) Pub. No.: US 2007/0253127 A1
(43) Pub. Date: Nov. 1, 2007

(54) ELECTROSTATIC DISCHARGE PROTECTION STRUCTURE OF ELECTRONIC DEVICE

(76) Inventors: Katsunori Sanefuji, Kanagawa (JP); Shigeru Yoshino, Kanagawa (JP); Torao Arata, Kanagawa (JP)

Correspondence Address: LADAS & PARRY LLP, 224 SOUTH MICHIGAN AVENUE, SUITE 1600, CHICAGO, IL, 60604, US

(21) Appl. No.: 11/738,570

(22) Filed: Apr. 23, 2007

(30) Foreign Application Priority Data
Apr. 28, 2006 (JP) 2006-125608

(51) Int. Cl. H02H 9/00

(52) U.S. Cl. 361/56

(57) ABSTRACT

An electrostatic discharge protection structure of an electronic device is disclosed. The electronic device includes an electrically insulating panel and an electrically insulating operation member fitted with respect to an opening of the panel. The operation member includes an operation member main body, a flange extending from the operation member main body, and a groove formed along a peripheral surface of the operation member main body in a face of the flange opposing the panel. The panel includes an enclosing rib along the edge of the opening on a back face thereof. The operation member is configured such that the operation member main body is fitted with respect to the inner side of the enclosing rib of the panel, and the groove is fitted with respect to the enclosing rib of the panel.

### BACKGROUND OF THE INVENTION

1. Field of the Invention

The present invention generally relates to an electrostatic discharge protection structure of an electronic device, and particularly relates to an electrostatic discharge protection structure for an operation member of a front panel of an electronic device.

2. Description of the Related Art

FIG. 6 is a diagram showing a structure of a related-art power button of an electronic device and the vicinity thereof. The reference numerals 1, 2, 3, and 4 indicate a power button, a front panel, a printed circuit board, and a power switch, respectively. Both the power button 1 and the front panel 2 are made of synthetic resin and have electrical insulating properties. Other electronic components are also mounted on the printed circuit board 3.

The power button 1 is fitted in an opening 2a of the front panel 2. When an operator presses the power button 1 with his fingertip, the power button 1 is displaced in the direction X1. Thus a projection 1b of the power button 1 presses and activates the power switch 4. There is a very narrow gap 5 between the power button 1 and the opening 2a of the front panel 2. The gap 5 is shown enlarged in FIG. 6 for clarity.

For instance, if an electrically excessively charged operator presses the power button 1 with his fingertip, the electricity may pass through the gap 5 to be discharged between the operator's finger tip and the printed circuit board 3, which can result in damage to the power switch 4.

In order to avoid such a problem, a flange 1a of the power button 1 has a predetermined width W1 such that a path from the opening 2a to the end of the flange 1a along the circumferential surface of the power button 1 is formed in an L shape. A distance L1 of the path increases electrostatic resistance.

It was found from an ESD (electrostatic discharge) test that the related-art electrostatic discharge protection structure has an electrostatic resistance of about 15 kV.

In recent years, there has been a demand for higher electrostatic resistance for enhanced reliability of electronic devices.

<Patent Document 1> Japanese Patent Laid-Open Publication No. 2000-323295

If the creeping distance L1 is increased by increasing the width W1 of the flange 1a of the power button 1, the electrostatic resistance increases. However, increase of the width W1 of the flange 1a of the power button 1 is limited due to the external shape of the electronic device.

There is an electrostatic discharge protection structure in which a component part (not shown) such as a conductor rod is provided on a printed circuit board 3 so that the electrostatic discharge is guided into the component part. This electrostatic discharge protection structure, however, has a problem of increased number of component parts.

### SUMMARY OF THE INVENTION

The present invention is directed to an electrostatic discharge protection structure of an electronic device that solves one or more of the aforementioned problems.

According to an aspect of the present invention, there is provided an electrostatic discharge protection structure of an electronic device. The electronic device includes an electrically insulating panel and an electrically insulating operation member fitted with respect to an opening of the panel. The operation member includes an operation member main body, a flange extending from the operation member main body, and a groove formed along a peripheral surface of the operation member main body in a face of the flange opposing the panel. The panel includes an enclosing rib along the edge of the opening on a back face thereof. The operation member is configured such that the operation member main body is fitted with respect to the inner side of the enclosing rib of the panel, and the groove is fitted with respect to the enclosing rib of the panel.

According to the above-described aspect of the present invention, the groove is formed in the flange, and the enclosing rib is formed on the panel. The groove is fitted with respect to the enclosing rib. With this configuration, the distance along the inner surface of the groove is added to the distance of a gap, which increases electrostatic resistance.

### BRIEF DESCRIPTION OF THE DRAWINGS

FIG. 1 is a cross-sectional view showing an electrostatic discharge protection structure of an electronic device according to Embodiment 1 of the present invention;

FIG. 2 is an exploded perspective view showing a front panel and a power button of FIG. 1;

FIG. 3 is a diagram showing the outlines of the power button and the front panel of FIG. 1 on which the outlines of a power button and a front panel of FIG. 6 are superposed;

FIG. 4 is a cross-sectional view showing an electrostatic discharge protection structure of an electronic device according to Embodiment 2 of the present invention; and

FIG. 5 is an exploded perspective view showing a front panel and a power button of FIG. 4;

FIG. 6 is a diagram showing a structure of a related-art power button of an electronic device and the vicinity thereof.

### DETAILED DESCRIPTION OF THE PREFERRED EMBODIMENT

The following describes preferred embodiments of the present invention.

### Embodiment 1

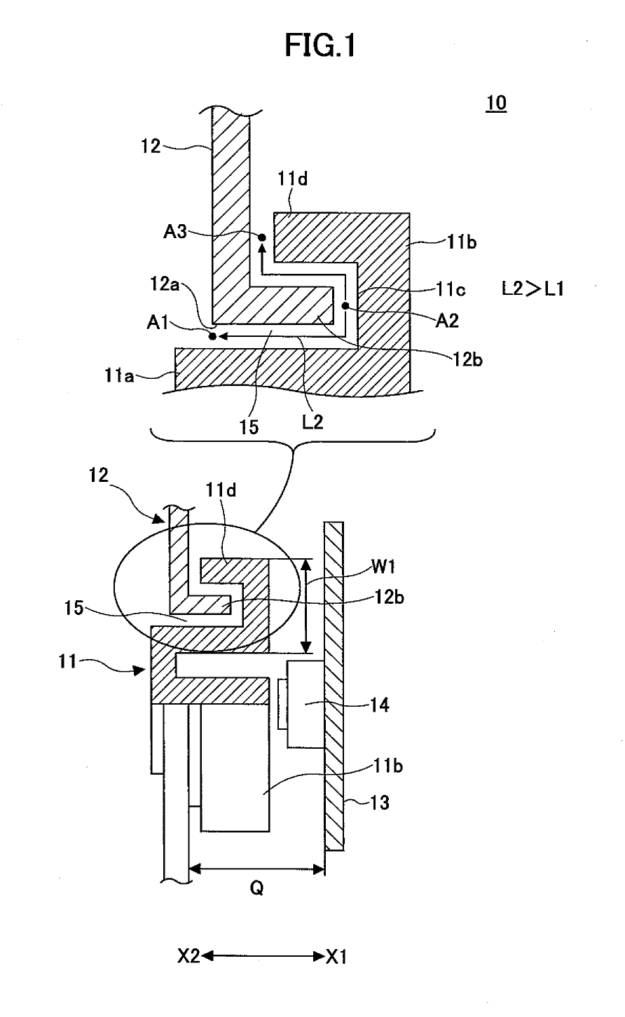

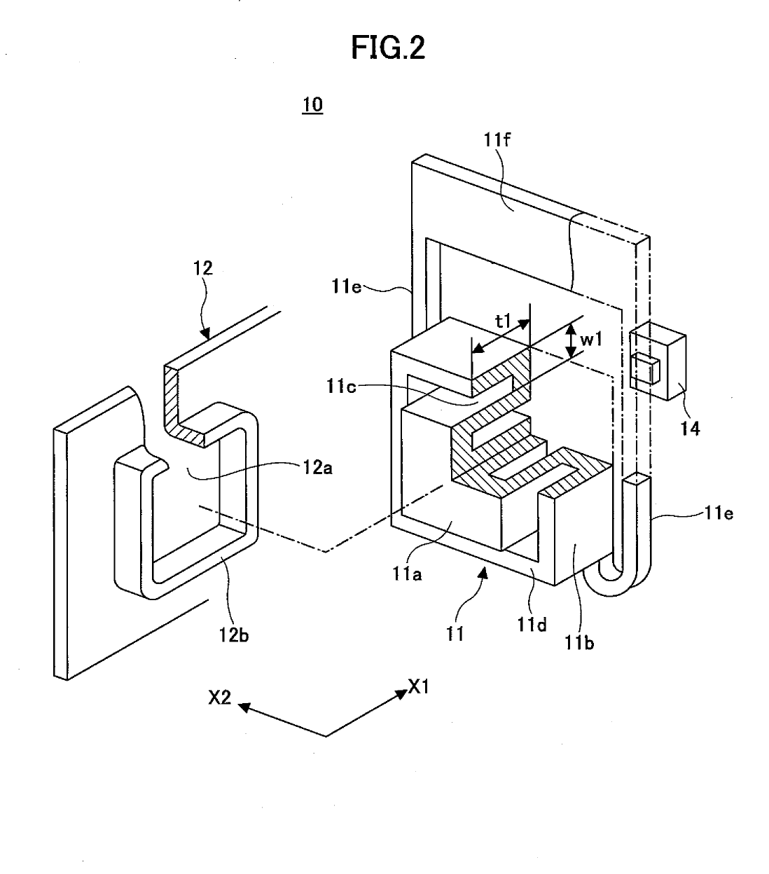

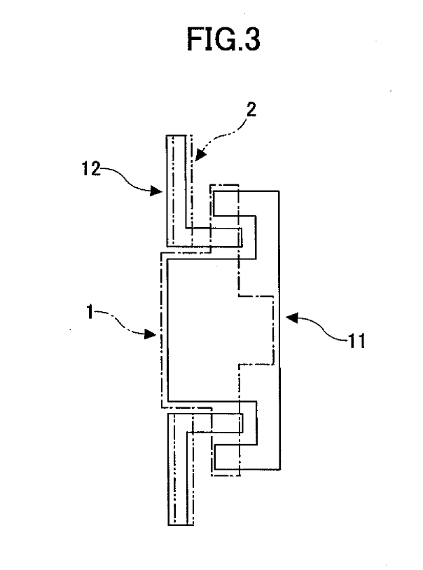

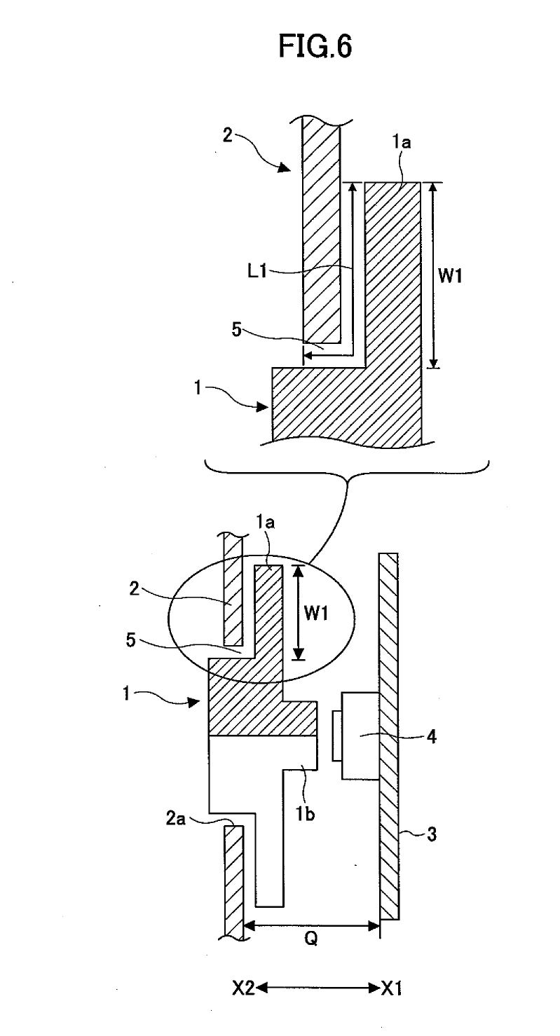

FIG. 1 is a cross-sectional view showing an electrostatic discharge protection structure 10 of an electronic device according to Embodiment 1 of the present invention. FIG. 2 is an exploded view showing a front panel 12 and a power button 11. FIG. 3 is a diagram showing the outlines (indicated by solid lines) of the power button 11 and the front panel 12 of FIG. 1 on which the outlines (indicated by two-dot chain lines) of the related-art power button 1 and the front panel 2 of FIG. 6 are superposed.

The reference numerals 11, 12, 13, and 14 indicate the power button of a press type, the front panel, a printed circuit board, and a power switch, respectively. Both the power button 11 and the front panel 12 are made of synthetic resin and have electrical insulating properties. The printed circuit board 13 is disposed near and at the back side of the front panel 12. The power switch 14 is mounted on the printed circuit board 13 at the back side of the power button 11. The direction X1 indicates the direction in which the power switch 14 is pressed. A distance Q between the printed circuit board 13 and the front panel 12 is equal to a distance Q (FIG. 6) between the printed circuit board 3 and the front panel 2 in the related art.

The power button 11 is fitted in an opening 12a of the front panel 12. When an operator presses the power button 11 with his fingertip, the power button 11 is displaced in the direction X1, thereby pressing and activating the power switch 14. There is a very narrow gap 15 between the power button 11 and the opening 12a of the front panel 12. The gap 15 is shown enlarged in FIG. 1 for clarity.

The power button 11 has a square shape when viewed from the direction X2, and includes a button main body 11a with a generally quadrangular prism shape and a flange 11b extending outward from the X1-side end of the power button main body 11a. A square continuous groove 11c is formed in the X2-side of the flange 11b along the peripheral surface of the power button main body 11a. A thickness t1 of the flange 11b is equal to the sum of the thicknesses of the flange 1a and the projection 1b (see FIG. 6) of the related-art power button 1. An extending width W1 (FIG. 1) is equal to the width W1 of the flange 1a of the related-art power button 1. A frame-like outer wall 11d is a peripheral portion of the flange 11b and defines the outer side of the groove 11c.

A pair of plate springs 11e extends from the flange 11b. Each of the plate springs 11e is connected to an attachment portion 11f.

The front panel 12 has a square frame-like enclosing rib 12b formed along the edge of the opening 12a and extending in the direction X1.

The groove 11c of the power button 11 and the enclosing rib 12b of the front panel 12 are fitted with respect to each other.

The power button 11 is secured at the attachment portion 11f thereof to the back face of the front panel 12. As shown in FIG. 1, the power button 11 is disposed at the back side of the front panel 12. The power button main body 11a is fitted in the opening 12a and in the inner side of the enclosing rib 12b while the groove 11c of the power button 11 is fitted over the enclosing rib 12b of the front panel 12, i.e., such that the enclosing rib 12b of the front panel 12 is received in the groove 11c of the power button 11. The power button 11 is biased in the direction X2 by the plate springs 11e formed integral therewith.

The following describes the gap 15 in greater detail with reference to an enlarged view in FIG. 1. The gap 15 extends in the direction X1 from the edge of the opening 12a as a starting point A1 to a point A2 at the bottom of the groove 11c, turns to the direction X2 at the point A2 to further extend between the outer wall 11d and the enclosing rib 12b in the direction X2, and ends at a point A3 at the upper end of the outer wall 11d. The gap 15 is formed not in an L shape but in a substantial U shape, and has a distance L2. Since the enclosing rib 12b of the front panel 12 is received in the groove 11c of the power button 11, the creeping distance L2 includes the distance along the inner surface of the groove 11c of the power button 11.

Accordingly, the distance L2 of the gap 15 in the electrostatic discharge protection structure 10 of the electronic device is made greater than the distance L1 of the gap 15 in the related art without increasing the size of the power button 11 viewed from the direction X2.

It was found from an ESD test that electrostatic resistance of the electrostatic discharge protection structure 10 is about 20 kV, which is 5 kV higher than that of the related art.

The electrostatic discharge protection structure 10 of an electronic device thus provides enhanced electrostatic resistance without increasing the size of the power button 11 and without making any special modifications to the printed circuit board 13 for more secure grounding and the like (e.g. provision of special components parts such as a conductor rod).

### Embodiment 2

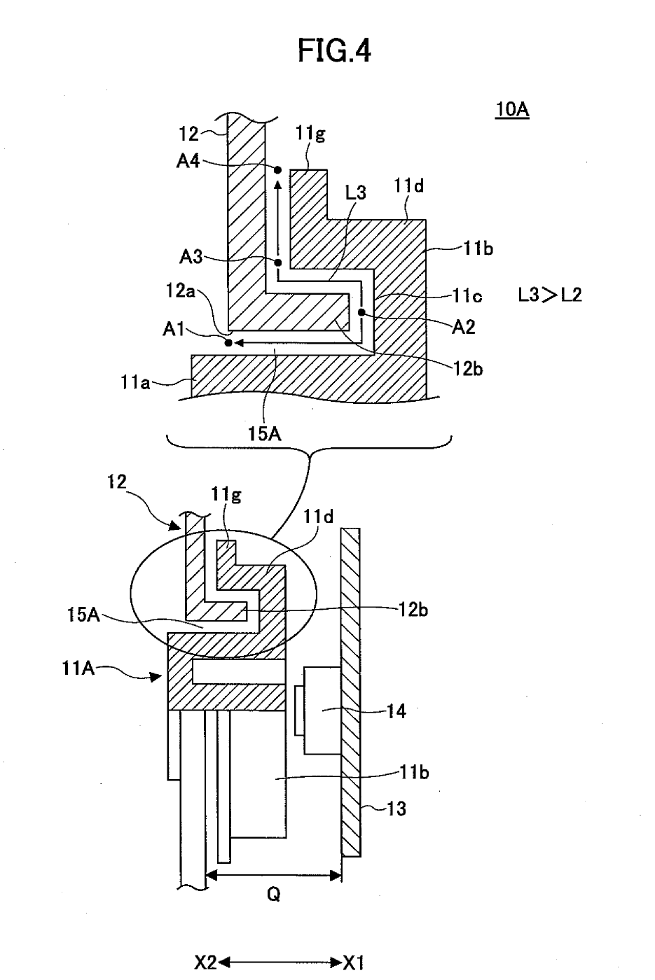

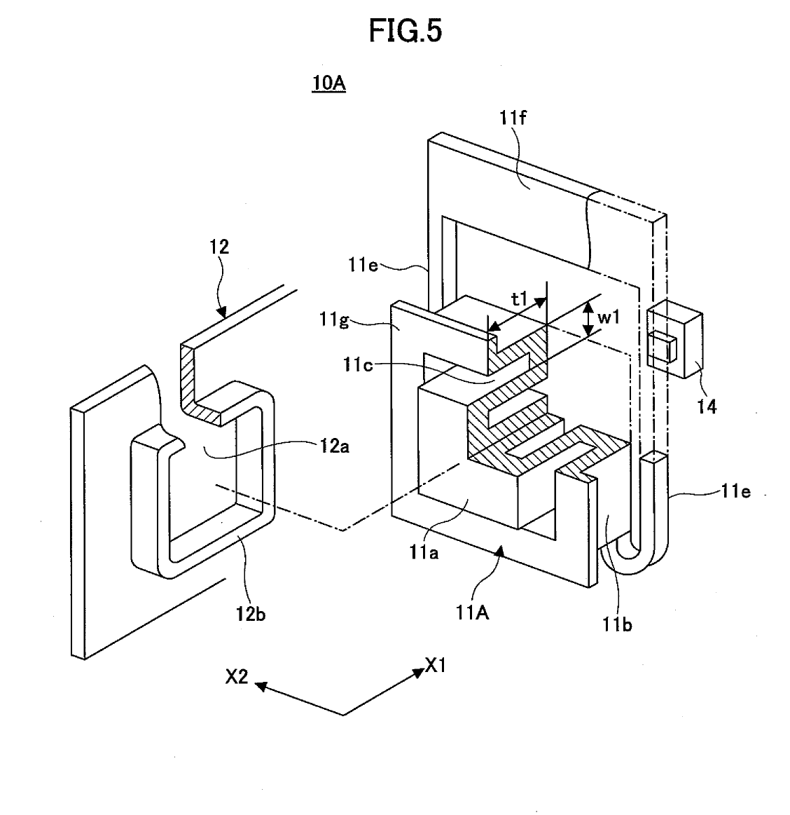

FIGS. 4 and 5 are diagrams each showing an electrostatic discharge protection structure 10A of an electronic device according to Embodiment 2 of the present invention. The electrostatic discharge protection structure 10A of the electronic device is different from the electrostatic discharge protection structure 10 of the electronic device of FIGS. 1 and 2 in the shape of a power button 11A. The power button 11A has an extending portion 11g extending outward from the edge of a flange 11b, i.e., the edge of an outer wall 11d. The extending portion 11g faces the back face of the front panel 12.

A gap 15A extends from the edge of an opening 12a as a starting point A1 through a point A2 and a point A3 to a point A4 at the edge of the extending portion 11g. A distance L3 of the gap 15A is greater than the distance L2 of the electrostatic discharge protection structure 10 of the electronic device of Embodiment 1. That is, the electrostatic discharge protection structure 10A of the electronic device provides higher electrostatic resistance.

The electrostatic discharge protection structures 10 and 10A of the electronic device are also applicable to press-type operation buttons other than the power buttons 11 and 11A, and to rotational operation knobs.

An operational member set forth in the appended claims corresponds to the power buttons 11 and 11A.

While the present invention is described in terms of preferred embodiments, it will be apparent to those skilled in the art that variations and modifications may be made without departing from the scope of the invention as set forth in the accompanying claims.

The present application is based on Japanese Priority Application No. 2006-125608 filed on Apr. 28, 2006, with the Japanese Patent Officer the entire contents of which are hereby incorporated by reference.

What is claimed is:

1. An electrostatic discharge protection structure of an electronic device, the electronic device comprising an electrically insulating panel and an electrically insulating operation member fitted with respect to an opening of the panel,
wherein the operation member includes an operation member main body, a flange extending from the operation member main body, and a groove formed along a peripheral surface of the operation member main body in a face of the flange opposing the panel;
the panel includes an enclosing rib along the edge of the opening on a back face thereof; and
the operation member is configured such that the operation member main body is fitted with respect to the inner side of the enclosing rib of the panel, and the groove is fitted with respect to the enclosing rib of the panel.

2. The electrostatic discharge protection structure of the electronic device as claimed in claim 1,
wherein the operation member further includes an extending portion extending outward from the face of the flange opposing the panel; and
the extending portion opposes the back face of the panel.
